(19) United States
(12) Patent Application Publication
(10) Pub. No.: US 2024/0380282 A1
(43) Pub. Date: Nov. 14, 2024

(54) ELECTRIC MACHINE, STATOR AND METHOD OF ASSEMBLY

(71) Applicant: Electrified Automation Limited, Bridgwater (GB)

(72) Inventor: Lloyd Conway ASH, Bridgwater (GB)

(73) Assignee: Electrified Automation Limited, Bridgwater, SO (GB)

(21) Appl. No.: 18/691,524

(22) PCT Filed: Sep. 13, 2022
(86) PCT No.: PCT/EP2022/075343

§ 371 Date: Mar. 13, 2024

(30) Foreign Application Priority Data
Sep. 14, 2021 (GB) 2113137.0

(51) Int. Cl. H02K 9/19; H02K 1/14; H02K 9/22; H02K 15/02; H02K 15/12

(52) U.S. Cl. CPC H02K 9/19; H02K 1/145; H02K 9/227; H02K 15/024; H02K 15/12; H02K 2203/12

(57) ABSTRACT

An electric machines, a stators for an electric machines and methods of assembly associated therewith are disclosed. The stator of embodiments comprises a stator core having an annular body and a plurality of poles projecting radially from the body and a coil mounted on and surrounding each pole of the stator core. Circumferentially adjacent coils are spaced apart to define a plurality of axially extending slots between adjacent poles. A moulded dielectric material encapsulating the stator core and coils. The dielectric material defines a plurality of bores extending into the axially extending slots of the stator.

### CROSS-REFERENCE TO RELATED APPLICATION

This application is a national stage application, filed under 35 U.S.C. § 371, of International Patent Application PCT/EP2022/075343, filed on Sep. 13, 2022, which claims the benefit of United Kingdom Patent Application GB 2113137.0, filed on Sep. 14, 2021.

### TECHNICAL FIELD

The present disclosure relates to electric machines, stators for electric machines and methods of assembly associated therewith.

### BACKGROUND

Electric machines (which it will be appreciated is used as a general term for a machine which uses electromagnetic forces such as an electric motor or generator) consist of a stator and a rotor and operate through the interaction of the machines magnetic field. A common stator configuration comprises a laminated body (which may, for example, be stamped from steel) defining a generally annular body with a plurality of radially extending pole teeth. Each pole tooth is surrounded by a coil which provides an electrical winding in the assembled electric machine.

In some electric machines the stator may be encapsulated in a dielectric material. Benefits of encapsulation include electrical insulation, protection, and heat dissipation. Such encapsulation, which may also be referred to as “potting”, involves placing the stator in a mould which is filled with a material such as an epoxy resin which sets to fully enclose the stator.

There is an ever-increasing desire to provide electric machines with high power and torque requirements, for example for the use in electric vehicles. Motors with high power and/or torque density may, for example, result in increased heat generation within the motor during use. As such, modern electric machines must be provided with effective cooling to ensure reliable and efficient operation. In particular, it is important to ensure that heat is dissipated from the stator to the exterior of the motor.

There is a need for electric machines and stators for electric machines with effective and/or improved cooling arrangements. Importantly, however, any cooling features should have a minimal impact on motor manufacture cost and time and be suitable for automated assembly.

### SUMMARY

According to one aspect of the invention, there is provided a stator comprising: a stator core having an annular body and a plurality of poles projecting radially from the body and a coil mounted on and surrounding each pole of the stator core. Circumferentially adjacent coils are spaced apart to define a plurality of axially extending slots between adjacent poles. A moulded dielectric material encapsulating the stator core and coils. The dielectric material defines a plurality of bores extending into the axially extending slots of the stator.

The applicant has found that the inclusion of bores between the coils can enable enhanced cooling of the stator. Conventionally, motor designs may rely upon the thermal conduction of the dielectric material to conduct heat away from the stator. Such arrangements typically rely upon the dielectric material to conduct heat to a radially outer surface of the stator assembly from where the heat may be dissipated (for example via a metallic casing of the motor which abuts the outer surface). Embodiments of the invention recognise that a drawback of such prior approaches is that the primary area of heat generation is at the coils-in conventional arrangements the path through which heat must be transferred from such coils is particularly long and may need to pass through several thermal junctions. For example, the Applicant has identified that in conventional designs the primary cooling path for the coils is for heat to be transferred into the stator core poles and then transfer from the body of the core to the encapsulation material at the exterior of the stator core and then to the casing of the motor. As such, embodiments of the invention may enhance overall thermal performance of the stator (and associated electric machine) by improving the direct cooling of the coils—i.e. encouraging heat dissipation directly from the coil to the encapsulation material without transfer through the stator core. Furthermore, the provision of bores in the dielectric material increases the surface area of the external side of the material, which enhances the heat dissipating capacity of the material.

In some embodiments the bores may be formed in a separate process to the moulding of the dielectric material—for example in a machining process. However, to reduce the manufacturing steps it is advantageous that the bores are formed in the moulding process. The dielectric material may, therefore, conform to the profile of the stator to form said plurality of bores. It will be appreciated that a conformal moulding surrounding the stator will take the shape of the stator and maintain the true shape of features such as the slots between adjacent coils to thereby form the bores.

The dielectric material may be a resin. The dielectric material may be a thermoplastic.

The bores may be blind bores in some embodiments. In other embodiments the bores may be open bores extending axially through the stator. The bore form and geometry may depend for example upon the stator configuration and/or the process used to form the dielectric material encapsulation. For example, in some embodiments the slots between adjacent coils may not extend axially through the stator but may only be partial recesses or groves formed at the axial end face by adjacent coils—in such an embodiment the bores would also be limited in axial depth.

In embodiments the stator may further comprising a heat sink. The heat sink may be
positioned adjacent to an axial end face of the stator. The stator may abut the dielectric material to provide a direct thermal coupling. The profile of the inner (stator facing) heat sink may be matched to the outer face of the encapsulated stator. The heat sink may for example be integral to a stator cover (which may be an outer cover or casing of an electric machine).

Advantageously, the heat sink may comprise a plurality of fins shaped each fin being configured to be received in a bore of the dielectric material. The fins may be an array of axially extending members projecting from an internal (i.e. stator facing) face of the heat sink. The profiles of the fins and bores may be matched. For example, the fins may push fit into the bores such that the outer surface of the fin directly abuts the dielectric material forming the wall of the bore. Additionally or alternatively, the fins may be coated or provided with a thermal compound during assembly to provide good thermal transfer from the dielectric material to the heat sink. The dimensions and shape of each fin may, therefore, be determined based upon the shape and configuration of the stator.

The inclusion of a heat sink with fins which extend into the bores of the dielectric material both increases the surface area of the heat sink and also reduces the heat transfer path from the coils of the stator to the heat sink.

Whilst embodiments may be suitable for use in a variety of electric machines, embodiments may be particularly suited to stators having a high fill factor (for example stators having coils comprising edge windings). As such, in some embodiments the coils of the stator may comprise edge windings. The high fill factor windings may be used in high performance applications and may therefore generate high heat levels in use. Advantageously, a high fill factor winding may also provide increased clearance between adjacent stator poles such that the plurality of axially extending slots between adjacent poles are particularly suitable for forming cooling bores in accordance with embodiments of the invention.

Embodiments of the invention are not limited to any specific method of forming the stator assembly. As embodiments are suitable for use in automated manufacture, the coils of the stator may for example be wound onto a bobbin formed of an insulated material which can be placed over the pole of the stator. Thus, in some embodiments, each coil of the stator may further comprise a bobbin, the windings of the coil being supported on the bobbin and the bobbin being mounted to the poles of the stator core.

According to further aspects of the invention there may be provided an electric machine comprising a stator in accordance with embodiments and a rotor.

The electric machine may further comprise a fluid coolant system. The fluid coolant system may be configured to circulate coolant through the plurality of bores of the dielectric material. The fluid coolant may for example be air or water (and may include one or more additives).

Whilst a coolant flow could be used in conjunction with blind bores this may result in stagnation of flow within the bores and, as such, embodiments having a fluid coolant system may have through bores. The fluid coolant system of embodiments may provide a flow of coolant to a first axial side of the stator and extract the flow of coolant from a second axial side of the stator. As such, the plurality of bores provide coolant flow channels, for example axial channels between the first and second side of the stator.

A further aspect of the invention comprises a method of assembling a stator, the method comprising the steps of:
providing a core assembly comprising a stator core having a plurality of poles and a plurality of coils, each mounted on a pole of the stator core; and
encapsulating the core assembly in a dielectric material which conforms to the profile of the core assembly to define a plurality of cooling bores, each bore extending axially between circumferentially adjacent coils.

Encapsulating the core assembly may comprises moulding the dielectric material over the core assembly.

The method may further comprise providing a heat sink in abutment with the dielectric material.

The method may be used in conjunction with any features of the embodiments described above.

Whilst the invention has been described above, it extends to any inventive combination of the features set out above or in the following description or drawings.

### BRIEF DESCRIPTION OF THE DRAWINGS

Embodiments of the invention may be performed in various ways, and embodiments thereof will now be described by way of example only, reference being made to the accompanying drawings, in which:

FIG. 1 show an electrical machine in accordance with an embodiment;

FIG. 2 shows an isolated end view of the stator core of FIG. 1;

FIG. 3 shows an axial cross-section of a portion of the stator core of FIGS. 1 and 2;

FIG. 4 shows a cross-section along circumferential plane A-A of FIG. 3 in accordance with one embodiment;

FIG. 5 shows the cross-section along circumferential plane A-A of FIG. 3 in accordance with another embodiment;

FIG. 6 shows the cross-section along circumferential plane A-A of FIG. 3 in accordance with another embodiment;

FIG. 7 shows an end view of a heat sink for use in embodiments;

FIG. 8 shows a cross section of the heat sink of FIG. 7 positioned with a stator assembly; and

FIG. 9 shows a method in accordance with embodiments.

### DETAILED DESCRIPTION

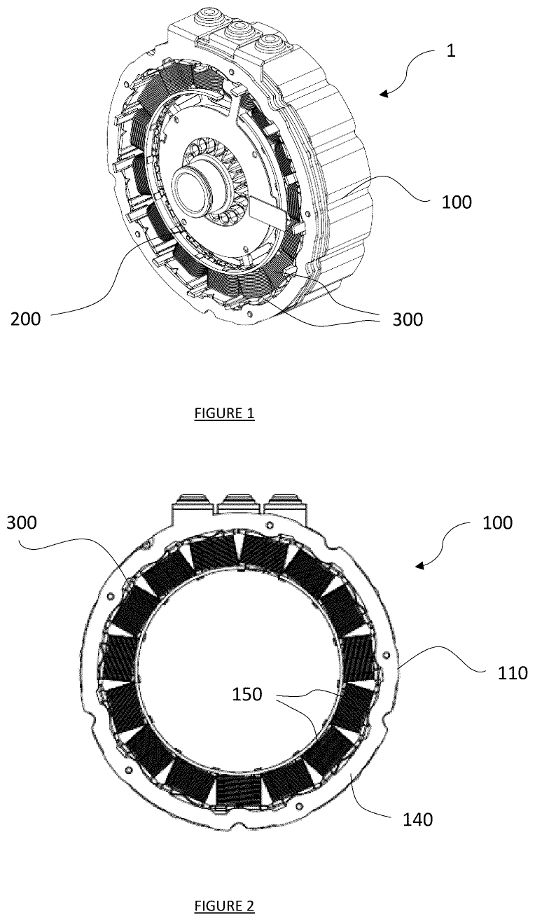

It may be noted that directional/orientational terms such as radial, circumferential, and axial may be used herein to refer to the general directions of the assembly or components thereof relative to their in-use configuration. The general directions are shown, by way of example only, by arrow R showing a radial direction, C showing a circumferential direction and A showing an axial direction in FIG. 1. However, the skilled person will appreciate that (unless expressly indicated otherwise) such directions are used broadly and do not imply strict mathematical/literal conformance with a particular orientation. Likewise, the use of such terminology does not exclude a component or feature having a non-circular or irregular form.

An electric machine 1 is shown in FIG. 1 and comprises a stator 100 surrounding a rotor 200. The stator comprises a stator core 110 and a plurality of coils 300 mounted on poles of the stator core 110.

The stator 100 is shown in isolation in FIG. 2. As will be known in the art, the stator core 110 may be formed from metal laminations which are stamped into the required shape. It may be appreciated that for ease of manufacture the stator core 110 may be formed from a plurality of individual core segments but the invention is not limited to any specific configuration. The stator core 110 comprises a body 140, which defines an annular ring of the stator core 110, and a plurality of pole teeth 150. A coil 300 is provided on and surrounding each pole tooth 150 (and in FIG. 2 the pole teeth are mostly obscured by the coils).

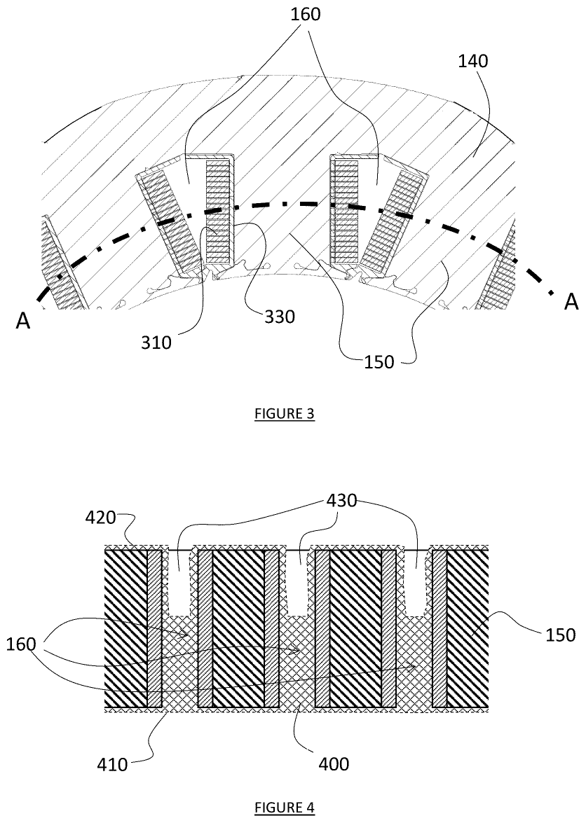

As best seen in the cross section of FIG. 3, the pole teeth 150 project from the annular ring of the body 140. In the example, the pole teeth 150 extend radially inwardly from the stator body 140. It may be noted from the cross-section, that the coils 300 comprise end windings on a supporting insulating bobbin 310 which enables a pre-wound coil to be slid over a pole tooth 150 in an automated manufacturing process. Between each adjacent pole tooth 150 and coil 300 there is an axially extending slot 160. Whilst the slots 160 in the illustrated embodiment are open slots extending through the full axial thickness of the stator assembly it will be appreciated that this is not essential. In some arrangements the slots may be recesses or grooves formed between adjacent stator coils 300 and may therefore only extend partially axially inwardly from the axial end face of the stator assembly.

FIGS. 4 to 6 show a cross-section taken along a circumferentially extending plane as shown by line A-A in FIG. 3. These figures illustrate the encapsulation of the stator 100 in a dielectric material 400 in accordance with embodiments of the invention (and it will be appreciated that the dielectric material 400 has been exclude from the previous figures for clarity purposes). The dielectric material 400 is, for example, an injection moulded plastic resin. The dielectric material 400 encapsulates the stator assembly 100 including the body 140, poles 150 and coils 300. The dielectric material 400, therefore, has opposed axial faces 410 and 420 on opposite sides of the stator 100. Bores 430 are defined by the outer surface of the dielectric material and extend into the axially extending slots 160 between each adjacent pole tooth 150 and coil 300. Whilst the bores 430 could be formed by machining (for example drilling) the dielectric material 400 after it is moulded around the stator 100, to simplify manufacture it is desirable to form the bores during the moulding step by ensuring the dielectric material is moulded as a conformal layer around the stator 100.

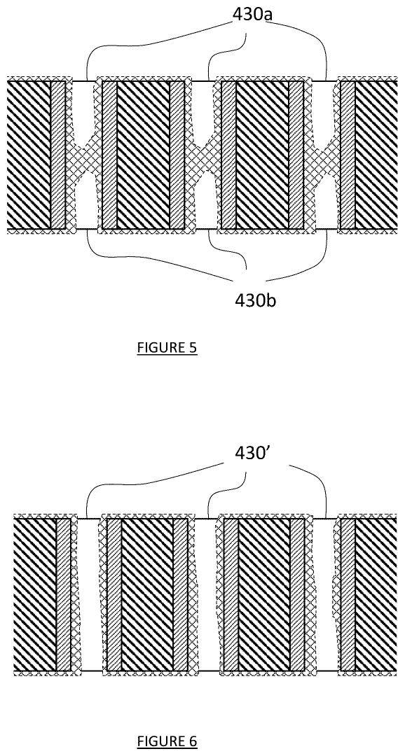

It may be noted that in FIG. 4 the bores 430 only extend partially through the stator slots 160 in the axial direction. Such an arrangement may be simpler to manufacture and may, for example, be acceptable for lower performance applications where thermal management is less critical. In FIG. 5 it can be seen that some embodiments may include partial bores 430a and 430b extending axially inwardly from each end face 410 and 420. In the embodiment of FIG. 6 bores 430′ are provided that extend fully axially through the slots 160 of the stator 100. An advantage of such through bores 430′ is that they may act as flow passages across the axial direction of the stator 100. This enables embodiments of the invention to use a coolant system to flow a coolant (which could be air, water, or another fluid) through the bores 430′ and provide significantly enhanced cooling.

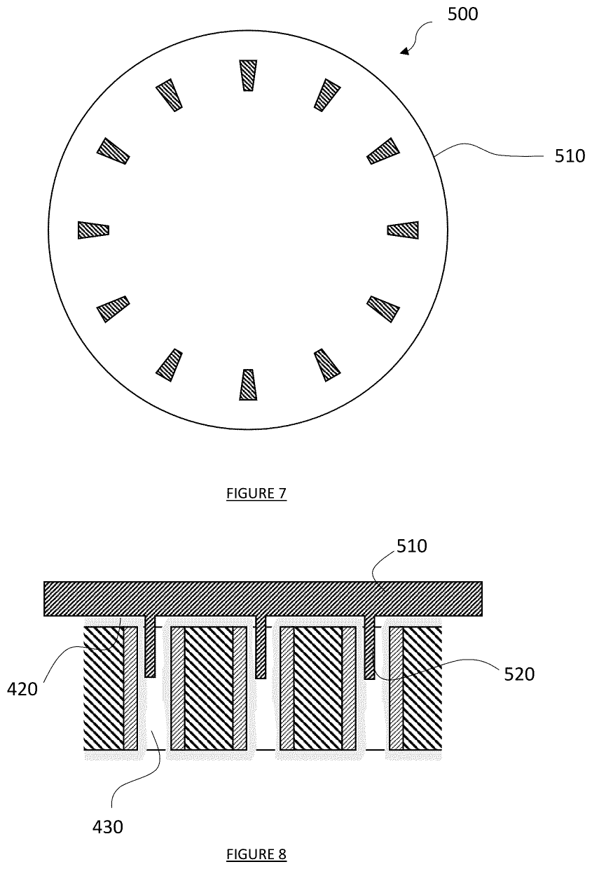

FIGS. 7 and 8 illustrate a heat sink 700 which may be included in some embodiments. The heat sink 700 shown has a generally disk-shaped body 710 and may be an integral part of a cover for enclosing an axial end face of the electric machine 1. Forming the heat sink as a cover ensures that the outer (non-stator facing) side of the heat sink/cover 700 is external to the electric machine 1 (and may therefore be exposed to ambient temperatures). A plurality of fins 720 are provided on the body 710 in a circumferentially spaced apart array 725. The shape and position of the array and the individual fins 720 and the array 725 is designed to match the shape and configuration of the stator 100 such that each fin 720 corresponds to a bore 430 and slot 160. As shown in the cross section of FIG. 8 when the heat sink 700 and stator are assembled the fins each locate into a respective bore 430. Whilst, for clarity, a gap is shown between the wall of the bore 430 and the outer surface of each fin 720, it may be appreciated that in practice this may be less optimum for heat transfer. As such a thermal compound or thermal paste may be provided during assembly to fill any such gaps and provide a heat transfer medium which will maximise heat transfer from the dielectric material to the fins. Alternatively, the surfaces may directly engage/abut to optimise thermal transfer therebetween. Thus, it can be seen that embodiments may provide a relatively short and direct heat transfer path from the coils 300 of the stator to the exterior of the housing via the dielectric material 400, bore 430, fin 720 and heat sink/cover 700. The reduced path allows heat transfer away from the coils 300 to be additionally and/or primarily axial rather than radial and thereby avoid additional or unnecessary thermal junctions.

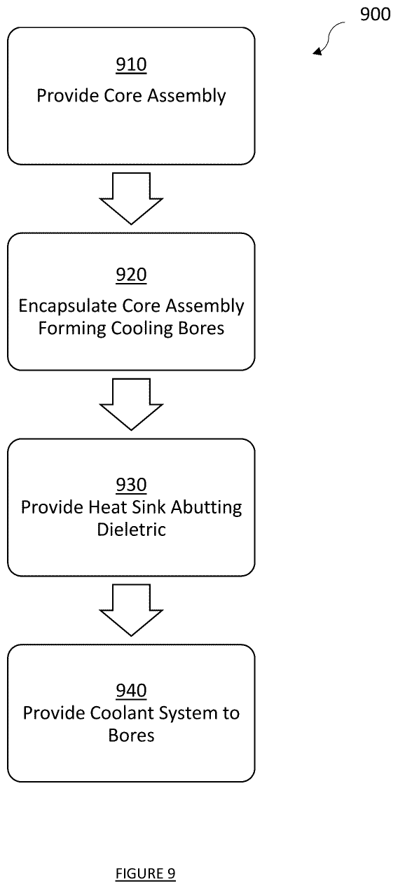

Embodiments also provide a method of making a stator and/or an electric machine including such a stator. A flow chart representing such a method is shown in FIG. 9. The method includes the step 910 of providing a core assembly comprising a stator core having a plurality of poles and a plurality of coils, each mounted on a pole of the stator core. The core assembly is then encapsulated in a dielectric material which conforms to the profile of the core assembly to define a plurality of cooling bores in step 920. Each bore extends axially between circumferentially adjacent coils. The method may further include the optional step 930 of providing a heat sink abutting the dielectric material. Optionally, a final step 940 may include providing a coolant system connected to the bores such that the bores can be provided with a coolant flow in use.

Although the invention has been described above with reference to preferred embodiments, it will be appreciated that various changes or modification may be made without departing from the scope of the invention as defined in the appended claims. For example, whilst the illustrated embodiment described above comprises an internal rotor and external stator embodiments of the invention need not be limited to such an arrangement. In this regard the skilled person will appreciate that some motors use a stator having an internal annular stator core with outwardly projecting pole teeth. It will be appreciated that embodiments of the present disclosure can easily be adapted to such an arrangement without the departing from the scope of the invention.

1. A stator comprising:
a stator core having an annular body and a plurality of poles projecting radially from the annular body;
a coil mounted on and surrounding each pole of the stator core, wherein circumferentially adjacent coils are spaced apart to define a plurality of axially extending slots between adjacent poles; and
a moulded dielectric material encapsulating the stator core and coils; wherein
the moulded dielectric material conforms to a profile of the stator to form a plurality of cooling bores extending into the axially extending slots of the stator.

2. The stator as claimed in claim 1, wherein the plurality of bores are open bores extending axially through the stator.

3. The stator as claimed in claim 1, further comprising a heat sink.

4. The stator as claimed in claim 3, wherein the heat sink is positioned adjacent to an axial end face of the stator.

5. The stator as claimed in claim 3, wherein the heat sink comprises a plurality of fins extending into the plurality of bores.

6. The stator as claimed in claim 3, wherein the heat sink is integral to a stator cover.

7. The stator as claimed in claim 1, wherein the coils comprise edge windings.

8. The stator as claimed in any preceding claim 1, wherein each coil further comprises a bobbin, windings of the coil being supported on the bobbin and the bobbin being mounted to the poles of the stator core.

9. An electric machine, comprising:
the stator as claimed in claim 1; and
a rotor.

10. The electric machine as claimed in claim 9, further comprising a fluid coolant system for circulating coolant through the plurality of bores of the moulded dielectric material.

11. The electric machine of claim 10, wherein the coolant is water.

12. The electric machine of claim 10, wherein the fluid coolant system provides a flow of coolant to a first axial side of the stator and extracts the flow of coolant from a second axial side of the stator such that the plurality of bores provide coolant flow channels.

13. A method of forming a stator, the method comprising:
providing a core assembly comprising a stator core having a plurality of poles and a plurality of coils, each mounted on a pole of the stator core; and
encapsulating the core assembly in a dielectric material which conforms to a profile of the core assembly to define a plurality of cooling bores, each bore extending axially between circumferentially adjacent coils.

14. The method of claim 13, wherein encapsulating the core assembly comprises moulding the dielectric material over the core assembly.

15. The method of claim 13, further comprising providing a heat sink in abutment with the dielectric material.
